(19) United States
(12) Patent Application Publication
(10) Pub. No.: US 2023/0088146 A1
(43) Pub. Date: Mar. 23, 2023

(54) SYSTEMS AND METHODS FOR AUTOMATED DESIGN

(71) Applicant: FERMI RESEARCH ALLIANCE, LLC, Batavia, IL (US)

(72) Inventors: Brian Dennis Nord, Geneva, IL (US); Benjamin McKinley Cohen, Rockville, MD (US)

(21) Appl. No.: 17/950,594

(22) Filed: Sep. 22, 2022

Related U.S. Application Data
(60) Provisional application No. 63/246,982, filed on Sep. 22, 2021.

(51) Int. Cl. G06F 30/20

(52) U.S. Cl. CPC G06F 30/20; G06F 2111/06

(57) ABSTRACT

A design optimization method and system comprises preparing a symbolic tree, updating node symbol parameters using a plurality of samples, sampling the plurality of samples with a method for solving, the multi-armed bandit problem, promoting each sample in the plurality of samples down a path of the symbolic tree, evaluating each path with a fitness function, and outputting a path of the symbolic tree.

### CROSS REFERENCE TO RELATED PATENT APPLICATIONS

This patent application claims the priority and benefit under 35 U.S.C. § 119(e) of U.S. Provisional Patent Application Ser. No. 63/246,982 filed Sep. 22, 2021, entitled “SYSTEMS AND METHODS FOR AUTOMATED DESIGN.” U.S. Provisional Patent Application Ser. No. 63/246,982 is herein incorporated by reference in its entirety.

### STATEMENT OF GOVERNMENT RIGHTS

The invention described in this patent application was made with Government support under the Fermi Research Alliance, LLC, Contract Number DE-AC02-07CH11359 awarded by the U.S. Department of Energy. The Government has certain rights in the invention.

### TECHNICAL FIELD

Embodiments are generally related to the field of design. Embodiments can be related to design of optical systems. Embodiments can be related to the field of circuit design. Embodiments can be related to the field of electrical system design. Embodiments are also related to the field of computer supported design. Embodiments are further related to the field of computer devices and mobile devices used for maximizing desired outputs for systems with discrete nodes with continuous parameters. Embodiments are also related to methods, systems, and devices for automated system design through approximate Bayesian Monte Carlo Tree search.

### BACKGROUND

Since the inception of modern computers, researchers have been interested in the automation of engineering pipelines. Design automation solutions are of great importance in a variety of fields because of the difficulty in evaluating and designing complex systems with many interlinked parameters.

Certain solutions have been studied in the context of optical systems, structural engineering, stamping dies, and circuits, among many other fields. It is expected that such methods, once integrated into the designer's pipeline, could lead to a substantially faster workflow because the engineer is able to optimize complex devices rapidly. Today, modern advances in computational power and machine learning techniques have revolutionized the automated design problem's landscape.

Approaches to automated design fall into a variety of categories. Neural network-based design approaches have become of interest recently due to the explosion of advances in the field. However, neural network-based approaches suffer from a variety of drawbacks, including the difficulty in creating the necessarily large training datasets and the associated high complexity.

Another approach for automated design is a genetic algorithm (GA). A GA is a method inspired by Darwinian evolution where a search through a design space is conducted through the iterative evolution of a specific design. Genetic algorithms are useful for design problems because they are highly parallelizable, and require neither problem specific information to make optimizations nor specific modifications depending on the problem. In addition, GA works with both a continuous and a discrete space. However, conventional GA methods are computationally intense and normally require substantial parameter tuning through trial and error for optimal operation.

Another approach is to use a damped least-squares based method. However, this process, as with other gradient-based methods, has difficulties in certain realms due to the high dimensionality and number of local optima. In addition, many of these methods are difficult to implement because design problems combine discrete and continuous search spaces (an example is element curvatures versus the number and type of element in optical systems).

As such, a need exists for improved automated design as disclosed herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide improved methods and systems for automated design.

It is another aspect of the disclosed embodiments to provide a method, system, and apparatus for improved automated optical design.

It is another aspect of the disclosed embodiments to provide a method, system, and apparatus for improved automated circuit design.

It is another aspect of the disclosed embodiments to provide a method, system, and apparatus for improved automated structural design.

It is another aspect of the disclosed embodiments to provide a method, system, and apparatus for improved automated electrical system design.

In the embodiments herein, a system, method, and apparatus are provided for general symbolic regression and automated design. The embodiments can be described as Approximate Bayesian Monte Carlo Tree Search (ABMCTS). The disclosed embodiments are advantageous because they do not need substantial problem specific information (other than a fitness function) making it useful for a variety of problems without substantial problem-specific tuning, or a large dataset. In addition to these advantages, the disclosed embodiments are able to provide the user key information about parameter distributions and metrics for how much more likely it is that a certain design choice is better than other choices.

In an embodiment a design optimization method comprises preparing a symbolic tree, updating node symbol parameters using a plurality of samples, sampling the plurality of samples with a method for solving the multi-armed bandit problem, promoting each sample in the plurality of samples down a path of the symbolic tree, evaluating each path with a fitness function, and outputting a path of the symbolic tree.

In an embodiment, the design optimization method comprises providing at least one design parameter. In an embodiment, the at least one design parameter comprises one of a discrete parameter and a continuous parameter. In an embodiment, the design optimization method comprises providing a plurality of design parameters, the plurality of design parameters further comprising: discrete parameters and continuous parameters. In an embodiment, the design optimization method the method for solving the multi-armed bandit problem comprises Thompson sampling. In an embodiment, the design optimization method comprises sampling using batch, computing a success rate, and updating Thompson parameters. In an embodiment, the design optimization method comprises providing an error function, the error function defining a design objective. In an embodiment, the design objective comprises an optical system design objective.

In another embodiment, a computer implemented optimization method comprises initializing a symbolic tree in a preparation phase, updating parameters held by each node in the symbolic tree using samples collected during an epoch in a parameter phase, evaluating at least one sample down the symbolic tree with Thompson sampling in order to select at least one sample in a Thompson phase, and updating parameter distributions using the selected at least one sample and incrementing the epoch in a rejection phase.

In an embodiment, the preparation phase further comprises generating a tree node with two sets of distributions, wherein each tree node contains a Thompson Distribution. In an embodiment, each node contains a plurality of parameter priors for each of its respective parameters. In an embodiment, the parameter phase further comprises determining a batch size and an error value for the epoch. In an embodiment, the parameter phase further comprises setting a batch size to be a number of samples taken in each rejection phase. In an embodiment, the parameter phase further comprises updating parameter distributions using saved samples and incrementing the epoch. In an embodiment, the rejection phase further comprises evaluating an error function for a selected path on the symbolic tree. In an embodiment, the error function defines a design objective.

In an embodiment, an optimization system comprises a computer system, the computer system further comprising: at least one processor, a graphical user interface, and a computer-usable medium embodying computer program code, the computer-usable medium capable of communicating with the at least one processor, the computer program code comprising instructions executable by the at least one processor and configured for: preparing a symbolic tree; updating node symbol parameters using a plurality of samples; sampling the plurality of samples with a method for solving the multi-armed bandit problem; promoting each sample in the plurality of samples down a path of the symbolic tree; evaluating each path with a fitness function; and outputting a path of the symbolic tree.

In an embodiment of the optimization system further comprises providing at least one design parameter, the at least one design parameter comprising one of a discrete parameter and a continuous parameter. In an embodiment of the optimization system the method for solving the multi-armed bandit problem comprises Thompson sampling further comprising sampling using batch, computing a success rate, and updating Thompson parameters. In an embodiment of the optimization system further comprises providing an error function, the error function defining a design objective.

### BRIEF DESCRIPTION OF THE FIGURES

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1 depicts a block diagram of a computer system which is implemented in accordance with the disclosed embodiments;

FIG. 2 depicts a graphical representation of a network of data-processing devices in which aspects of the present embodiments may be implemented;

FIG. 3 depicts a computer software system for directing the operation of the data-processing system depicted in FIG. 1, in accordance with an example embodiment;

FIG. 4 depicts a symbolic tree, in accordance with the disclosed embodiments;

FIG. 5 depicts the structure of a likelihood-free inference in the tree structured search-space, in accordance with the disclosed embodiments;

FIG. 6 depicts a block diagram of a system for automated design, in accordance with the disclosed embodiments;

FIG. 7A depicts aspects of a feedback loop, in accordance with the disclosed embodiments;

FIG. 7B depicts aspects of a feedback loop with failure assumptions, in accordance with the disclosed embodiments;

FIG. 8 depicts a block diagram of a system for automated design, in accordance with the disclosed embodiments;

FIG. 9 depicts a block diagram of a system for automated design, in accordance with the disclosed embodiments;

FIG. 10 depicts a symbolic subtree for an optical design problem, in accordance with the disclosed embodiments;

FIG. 11A depicts a trace and diagram of output, in accordance with the disclosed embodiments;

FIG. 11B depicts an error function over each epoch, in accordance with the disclosed embodiments;

FIG. 11C depicts unscaled components of error over each epoch, in accordance with the disclosed embodiments;

FIG. 12 depicts statistical outputs for an optical design optimization problem, in accordance with the disclosed embodiments; and

FIG. 13 depicts approximate parameter distributions for an optical design optimization problem, in accordance with the disclosed embodiments.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter, with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope and concept of the invention as defined by the appended claims.

The following terms, as used herein, are defined as follows:
Batch Function: The function linking batch size to the epoch.
Batch Size: The number of samples taken during the Rejection Phase.
Epoch: A full cycle through each of the three phases (Parameter Phase, Thompson Phase, and Rejection Phase).
Epsilon Function: The function linking ε to the epoch.
Epsilon: The acceptable error in the rejection sampling during the Rejection Phase. If C(sample, ytrue)<ε, a sample is accepted by the algorithm for use in future computation.
Required: The required number of samples of a given node to result in a parameter distribution update.
Thompson Update: The process of updating the Thompson Distributions throughout the tree that have additional samples to consider.

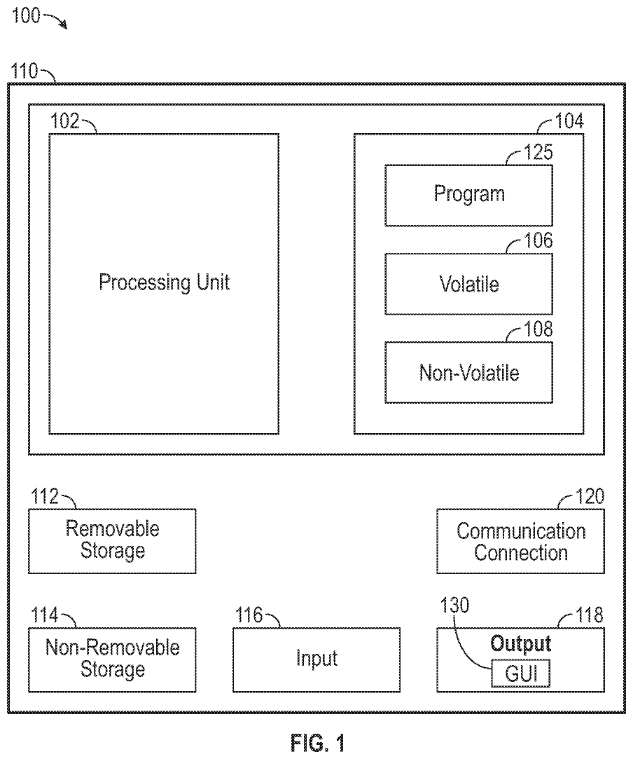

FIGS. 1-3 are provided as exemplary diagrams of data-processing environments in which embodiments of the present invention may be implemented. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 100 that executes programming for implementing parts of the methods and systems disclosed herein is shown in FIG. 1. A computing device in the form of a computer 110 configured to interface with sensors, peripheral devices, and other elements disclosed herein may include one or more processing units 102, memory 104, removable storage 112, and non-removable storage 114. Memory 104 may include volatile memory 106 and non-volatile memory 108. Computer 110 may include or have access to a computing environment that includes a variety of transitory and non-transitory computer-readable media such as volatile memory 106 and non-volatile memory 108, removable storage 112 and non-removable storage 114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data including image data.

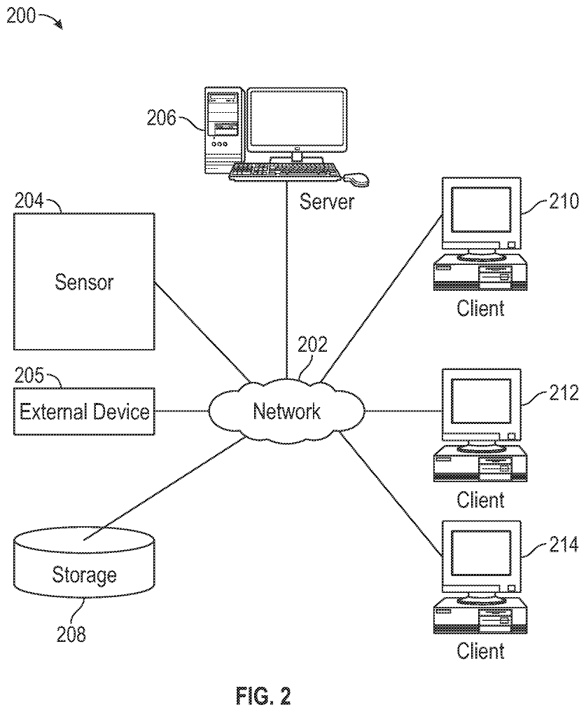

Computer 110 may include or have access to a computing environment that includes input 116, output 118, and a communication connection 120. The computer may operate in a networked environment using a communication connection 120 to connect to one or more remote computers, remote sensors, detection devices, hand-held devices, multi-function devices (MFDs), mobile devices, tablet devices, mobile phones, Smartphones, or other such devices. The remote computer may also include a personal computer (PC), server, router, network PC, RFID enabled device, a peer device or other common network node, or the like. The communication connection may include a Local Area Network (LAN), a Wide Area Network (WAN), Bluetooth connection, or other networks. This functionality is described more fully in the description associated with FIG. 2 below.

Output 118 is most commonly provided as a computer monitor, but may include any output device. Output 118 and/or input 116 may include a data collection apparatus associated with computer system 100. In addition, input 116, which commonly includes a computer keyboard and/or pointing device such as a computer mouse, computer track pad, or the like, allows a user to select and instruct computer system 100. A user interface can be provided using output 118 and input 116. Output 118 may function as a display for displaying data and information for a user, and for interactively displaying a graphical user interface (GUI) 130.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 116 such as, for example, a pointing device such as a mouse and/or with a keyboard. A particular item can function in the same manner to the user in all applications because the GUI provides standard software routines (e.g., module 125) to handle these elements and report the user's actions. The GUI can further be used to display the electronic service image frames as discussed below.

Computer-readable instructions, for example, program module or node 125, which can be representative of other modules or nodes described herein, are stored on a computer-readable medium and are executable by the processing unit 102 of computer 110. Program module or node 125 may include a computer application. A hard drive, CD-ROM, RAM, Flash Memory, and a USB drive are just some examples of articles including a computer-readable medium.

FIG. 2 depicts a graphical representation of a network of data-processing systems 200 in which aspects of the present invention may be implemented. Network data-processing system 200 is a network of computers or other such devices such as mobile phones, smartphones, sensors, detection devices, and the like in which embodiments of the present invention may be implemented. Note that the system 200 can be implemented in the context of a software module such as program module 125. The system 200 includes a network 202 in communication with one or more clients 210, 212, and 214, and external device 205. Network 202 may also be in communication with one or more external devices, including but not limited to RFID and/or GPS enabled devices or sensors 204, servers 206, and storage 208. Network 202 is a medium that can be used to provide communications links between various devices and computers connected together within a networked data processing system such as computer system 100. Network 202 may include connections such as wired communication links, wireless communication links of various types, fiber optic cables, quantum, or quantum encryption, or quantum teleportation networks, etc. Network 202 can communicate with one or more servers 206, one or more external devices such as RFID and/or GPS enabled device 204, and a memory storage unit such as, for example, memory or database 208. It should be understood that external device 204 may be embodied as a mobile device, cell phone, tablet device, monitoring device, detector device, sensor microcontroller, controller, receiver, transceiver, or other such device.

In the depicted example, external device 204, server 206, and clients 210, 212, and 214 connect to network 202 along with storage unit 208. Clients 210, 212, and 214 may be, for example, personal computers or network computers, handheld devices, mobile devices, tablet devices, smartphones, personal digital assistants, microcontrollers, recording devices, MFDs, etc. Computer system 100 depicted in FIG. 1 can be, for example, a client such as client 210 and/or 212.

Computer system 100 can also be implemented as a server such as server 206, depending upon design considerations. In the depicted example, server 206 provides data such as boot files, operating system images, applications, and application updates to clients 210, 212, and/or 214. Clients 210, 212, and 214 and external device 204 are clients to server 206 in this example. Network data-processing system 200 may include additional servers, clients, and other devices not shown. Specifically, clients may connect to any member of a network of servers, which provide equivalent content.

In the depicted example, network data-processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 200 may also be implemented as a number of different types of networks such as, for example, an intranet, a local area network (LAN), or a wide area network (WAN). FIGS. 1 and 2 are intended as examples and not as architectural limitations for different embodiments of the present invention.

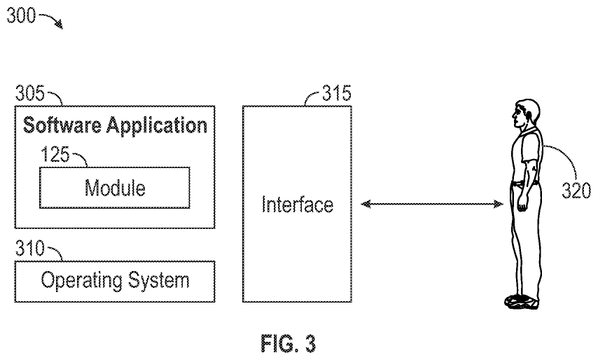

FIG. 3 illustrates a software system 300, which may be employed for directing the operation of the data-processing systems such as computer system 100 depicted in FIG. 1. Software application 305, may be stored in memory 104, on removable storage 112, or on non-removable storage 114 shown in FIG. 1, and generally includes and/or is associated with a kernel or operating system 310 and a shell or interface 315. One or more application programs, such as module(s) or node(s) 125, may be “loaded” (i.e., transferred from removable storage 114 into the memory 104) for execution by the data-processing system 100. The data-processing system 100 can receive user commands and data through user interface 315, which can include input 116 and output 118, accessible by a user 320. These inputs may then be acted upon by the computer system 100 in accordance with instructions from operating system 310 and/or software application 305 and any software module(s) 125 thereof.

Generally, program modules (e.g., module 125) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smart phones, tablet devices, multi-processor systems, printers, copiers, fax machines, multi-function devices, data networks, microprocessor-based or programmable consumer electronics, networked personal computers, minicomputers, mainframe computers, servers, medical equipment, medical devices, and the like.

Note that the term module or node as utilized herein may refer to a collection of routines and data structures that perform a particular task or implements a particular abstract data type. Modules may be composed of two parts: an interface, which lists the constants, data types, variables, and routines that can be accessed by other modules or routines; and an implementation, which is typically private (accessible only to that module), and which includes source code that actually implements the routines in the module. The term module may also simply refer to an application such as a computer program designed to assist in the performance of a specific task such as word processing, accounting, inventory management, etc., or a hardware component designed to equivalently assist in the performance of a task.

The interface 315 (e.g., a graphical user interface 130) can serve to display results, whereupon a user 320 may supply additional inputs or terminate a particular session. In some embodiments, operating system 310 and GUI 130 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 310 and interface 315. The software application 305 can include, for example, module(s) 125, which can include instructions for carrying out steps or logical operations such as those shown and described herein.

The following description is presented with respect to embodiments of the present invention, which can be embodied in the context of, or require the use of a data-processing system such as computer system 100, in conjunction with program module 125, and data-processing system 200 and network 202 depicted in FIGS. 1-3. The present invention, however, is not limited to any particular application or any particular environment. Instead, those skilled in the art will find that the systems and methods of the present invention may be advantageously applied to a variety of system and application software including database management systems, word processors, and the like. Moreover, the present invention may be embodied on a variety of different platforms including Windows, Macintosh, UNIX, LINUX, Android, Arduino and the like. Therefore, the descriptions of the exemplary embodiments, which follow, are for purposes of illustration and not considered a limitation.

In the embodiments disclosed herein, the method combines Approximate Bayesian Computation (ABC) with Thompson Sampling while exploring paths down a search tree of possible combinations of elements. Each tree node holds statistical distributions for the parameters of its element. When a node is sampled as part of a path, its parameter values are also sampled from its distributions. Therefore, while sampling for the ABC part of the algorithm, the method also learns what paths down the tree seem to work better by concurrently treating paths as bandits in the multi-armed bandit problem. As it learns what paths seem to work better, it samples those paths more, creating a feedback loop that converges upon the best path with the best parameter values. Importantly, the acceptable error (designated as epsilon) decreases as the algorithm runs, tightening the feedback loop and pushing the method toward convergence.

To begin, the algorithm prepares itself by generating the symbolic tree. This tree must hold within it the entire discrete search space. In this form, the search space should be ordered such that path choices higher in the tree have a larger effect on the resulting path's performance than decisions lower in the tree. This ordering helps validate the aforementioned feedback loop. After preparation, the structure of the algorithm is based on three nested phases: the Parameter Phase, Thompson Phase, and Rejection Phase.

In the Parameter Phase, the algorithm computes the batch size and the epsilon for the other nested phases. It then runs the other nested phases. Finally, using the results from the nested phases, at the end of the Parameter Phase, the algorithm updates the element parameter distributions and then moves to the next epoch.

In the Thompson Phase, the algorithm first samples from the tree within the nested Rejection Phase. Next, using the results of that rejection sampling, the algorithm computes the success rate of choosing each child at each node. Finally, the Thompson Distributions are updated according to Thompson Sampling using the computed success rates, constraining the tree. In the embodiments herein, this phase repeats itself a fixed number of times; however, in other embodiments, the phase can be repeated a dynamic number of times.

Finally, in the Rejection Phase, the rejection sampling occurs. Per the batch size, the tree is sampled through choosing a path according to the rules of Thompson Sampling, sampling the parameter distributions on that path, and evaluating the path with some provided fitness function. If the path is accepted, the algorithm increments the “number of successes” variable in each node in the path and saves the samples. Otherwise, the algorithm increments the “number of failures” variable in each node in the path. These variables are used in the Thompson Phase to compute the success rate.

In the embodiments herein, a system, method, and apparatus for automated design is disclosed. The concept that automated design problems are, essentially, symbolic regression problems provide the backdrop for the embodiments disclosed herein.

The general automated design problem (ADP) has two distinct, though interrelated, optimization challenges: the discrete aspects and the continuous aspects. Generally, the inputs to the ADP are a set D={d1, d2 . . . dn} where di is an individual element that the design could use in the system. Each di has explicit behavior depending on a set of parameters Pi={p1, p2 . . . pn} where pj is a continuous or piecewise continuous parameter. Together, these spaces correspond to the parts required to build the system space S. In addition to D, an automated design problem must have some objective for the system. This objective is specified as an error or loss function F: s∈S→c∈R where c is the cost, loss, or error of the system.

In such an ADP, the resulting system s must be explicitly constructed out of an ordered set D where ∀di∈D,di∈D. In the majority of cases, the structure of a system S is congruent to an equation with common mathematical operations. That is, s is built from a structured tree of its elements. The methods and systems disclosed herein are directed to such design problems and solutions. Therefore, each di also must have a fixed set of inputs or connections to other elements. Variable-input elements could be included in such a definition if they are split into multiple elements each with distinct numbers of inputs. Thus, the automated design problem can be understood as the problem of finding the optimal ordered set D such that ∀d∈D,d∈D and the corresponding optimal parameter values Pi∀di∈D where the minimization is met, as shown in equation (1):

$$F ( D , \{ {P}_{1 ,} {P}_{2 ,} … {P}_{n ,} \} ) = {min}_{𝕊} ( F ) \qquad ( 1 )$$

In certain embodiments, the disclosed methods and systems can be applied to optical systems or electrical systems. A simple example of such a setup is a geometric optical system where the input state is some input vector of rays, and each optical element transforms the rays until an output is computed. Another example would be an electrical system that takes some input signal and then transforms that signal until an output is reached.

The results of symbolic regression can be translatable to automated design. This is useful because symbolic regression fitness functions are much faster to evaluate than most automated design fitness functions. In addition, symbolic regression functions have easily controllable and analyzable shapes and forms.

The disclosed embodiments are constructed of a combination of approximate Bayesian computing and Thompson sampling to solve the general ADP problem.

In parameter estimation problems, Bayesian Inference is the collection of methods to calculate the posterior distribution of the parameters (θ) using observations and a prior distribution p(θ) according to Bayesian statistics. Specifically, these methods make use of Bayes' Rule given by equation (2):

$$p ( \vec{θ} \vert \vec{x} ) = \frac{p ( \vec{θ} \vert \vec{x} ) p ( \vec{θ} )}{p ( \vec{x} )} \qquad ( 2 )$$

where \vec{x} represents the observed data and p(\vec{x}|\vec{θ}) is the likelihood function. In such a problem, it is common for the likelihood function to be either very difficult or impossible to calculate. To solve this problem approximate Bayesian computation (ABC) can be used.

ABC methods approximate the posterior distribution through the process of rejection sampling. This process has three steps: first, parameter samples are drawn from a prior; second, a simulator is run on the sample data with its behavior constrained by those parameter choices; and third, error between the simulated results and the ground truth results is computed. If this error is below some tolerance ε, the sample is retained. Otherwise, the sample is disregarded. As ε→0, the retained samples approach samples from the posterior distribution.

ABC alone is a poor solution for ADPs because ABC methods suffer considerably from the “curse of dimensionality,” or difficulty with problems having a large parameter dimensionality. For example, for most ADPs, the dimensionality of the search space is very high due to the generally large number of design parameters.

To help address the curse of dimensionality, a sequential monte carlo (ABCSMC) approach can be used. In this approach, intermediate distributions are formed using a monotonically diminishing ε between the prior distribution and the approximated posterior. The t^{th} intermediate distribution is computed through the application of rejection sampling to the (t−1)^{st} intermediate distribution.

Samples from the (t−1)^{st} intermediate distribution can be taken through the application of some perturbation kernel K to a weighted random sample of the points that make up the (t−1)^{st} intermediate distribution. The weights for random selection are calculated sample-wise for the i^{th} sample according to equation (3):

$${w}_{n - 1}^{( i )} = \frac{π ( {θ}_{n - 1}^{( i )} =}{{\sum }_{j = 1}^{N} {w}_{n - 2}^{i} {K}_{n - 1} ( {θ}_{n - 1}^{( i )} \vert {θ}_{n - 2}^{( j )} )} \qquad ( 3 )$$

where π is the specified prior. This has significant advantages over other common methods of approximate Bayesian computation. It is robust against both stochastic and deterministic models and is more sample efficient than its competition.

It should be appreciated that these methods are approximate. Instead of drawing samples from the posterior p(θ|x), these techniques draw from p(θ|M(θ)−x<ε) where M is the model.

The other aspect of the disclosed systems and methods include incorporation of Thompson sampling. Multi-armed bandit problems encompass the dilemma of balancing between exploring a situation and exploiting information that has already been found. A classic example of a multi-armed bandit problem involves playing a set of slot machines. In a multi-armed bandit problem, the user aims to optimize their return after T steps where, in each step, they play a machine M where M∈{M1, M2, M3, M4 . . . Mn}. In the slot machine example, each M would represent an individual slot machine that the user could play to maximize their payout. With each pull, the player is provided a random reward X∈[0,1] sampled from some unknown distribution specific to M. The goal of the multi-armed bandit solution is then to maximize the reward after T steps by using information from previous pulls to influence the next choice of machine.

Thompson Sampling is essential to the disclosed embodiments, as it relates to the multi-arm bandit problem. As disclosed herein, the key to Thompson Sampling is the assignment of beta distributions (hence-forth referred to as Thompson distributions to avoid confusion with the other posterior distributions in approximate Bayesian computation) to each machine and the subsequent modification of those Thompson distributions' parameters depending on the reward given at step Tₙ. Specifically, after each step, the following update is applied to the sampled machine's α and β according to reward Xₜ∈[0, 1], illustrated in equations (4) and (5).

αₜ=αₜ₋₁+Xₜ (4)

βₜ=βₜ₋₁+1−Xₜ (5)

For example, according to Thompson Sampling, a machine to play can be selected by comparing samples from each machine's respective Thompson Distribution. The machine with the largest sample can be played. Statistically, the probability a machine is selected is equal to the probability that its success rate is highest.

Thompson Sampling is useful for the disclosed embodiments because of three of its key attributes. First, it has excellent empirical performance in comparison to other solutions to the multi-armed bandit problem. Second, it is simple to implement (although potentially computationally intensive due to its need to repeatedly sample from distributions). Third, and most critically, it provides a Bayesian metric (the machines' Thompson distributions) on how likely the algorithm is to choose one machine over another—and the distribution of success rates for a given design choice—which is vital for understanding the landscape of a design environment.

Additionally, in some contexts, a non-stationary version of the Thompson Sampling algorithm can be used in order to avoid falling into a local minimum. In this modification of normal Thompson Sampling, both α and β are moved towards their initial values (α=2, β=2) by some percentage at every update. Specifically, a and b are defined as placeholder variables and update them as illustrated in (6)-(9):

a₀=0 (6)

b₀=0 (7)

aₜ=γaₜ₋₁+Xₜ (8)

bₜ=γbₜ₋₁+Xₜ (9)

where γ is the discounting ratio. Additionally, non-stationary Thompson Sampling sets αₜ and βₜ as in (10) and (11):

αₜ=2+αₜ (10)

βₜ=2+bₜ (11)

Under this modification, the parameters of the beta distributions are exponentially discounted, and Thompson Sampling forgets what it learned early in the training. This method is more applicable to cases where the reward distributions change over time.

One of the critical difficulties in the general ADP is the correspondence between the elements and the parameters. As each element's behavior depends on its parameters, the optimal parameter values depends on the specific set of elements, a feedback loop between the optimal parameters and optimal elements is created that is challenging to overcome.

Using a tree structure allows the relationships between different elements to be explicitly included within the optimization. The specific generation scheme for the search tree may be dependent on the application—especially if the user wants to limit the search space based on physical constraints—but it must satisfy some basic requirements for optimization.

The first is validity. Each path down the tree should be an evaluable design or function. In other words, the error function must be applicable to every path down the tree. Note that this does not mean each path with each possible parameter sample must be valid, as it is possible (and common in ADPs) to have the fitness function return some large error in the case of an invalid design. The constraint here is only that the fitness function must be able to interpret the path.

The second is duplicate paths. It is optimal that paths are not duplicated in the tree. Duplicated paths may take many forms, including nodes ordered in reverse with commutative operators or the inclusion of irrelevant nodes (e.g., a scaler node of 1). That being said, it is generally difficult to find duplicate paths as they could be due to specific parameter samples from continuous distributions. The effect of duplicate paths is that certain paths are sampled more than others, biasing the algorithm for certain choices and against others.

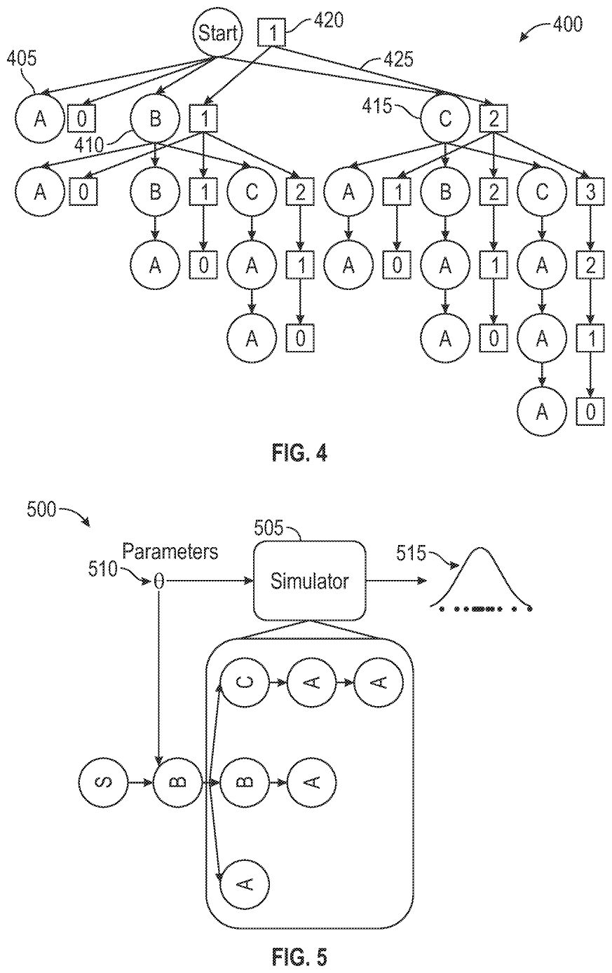

An exemplary illustration of a search tree 400 is provided in FIG. 4. Node A 405 represents some constant or input, Node B410 represents some unary function, and Node C 415 represents some binary function. The numbers 420 show connections and arrows 425 show updates to the O variable during generation.

For purposes of example, general prefix tree generation algorithm (GPTG) is used for this example. The implemented method takes in D and corresponding input dimensions, d.l. The GPTG implemented here assumes that variables or constants are functions with an input dimensionality of 0. In addition, the GPTG has a depth input m that corresponds to the maximum number of non-variable and non-constant elements in a path (e.g., functions).

The pseudocode for the GPTG used in this work can be seen in Algorithm 1.

```
Algorithm 1 General Prefix Tree Generation Algorithm
  m > 0 \hat{ } LEN(D)> 0
  T NODE( )
  procedure gpt g( O,node,depth)
    if O ≤ 0 then return
    else if depth ≥ m then
      for d 2 D do
        if d.I = 0 then
          n = NODE(d)
          node.addChild(n) . adding new child with the symbol
  below the current node
          GPTG( O = O − 1,node= n,depth= depth+ 1)
        end if
      end for
    else
      for d 2 D do
        n NODE(d)
        node.addChild(n)
        if d.I [symbol]   0 then
          GPTG( O = d.I + O − 1,node= n,depth= depth+ 1)
        else
          GTPG( O = O − 1,node= n,depth= depth)
        end if
      end for
    end if
  end procedure
```

At the center of the algorithm is the running input tally O. O can be thought of as the number of bins that are available to place new elements into. For instance, when placing a binary element into a system, the element itself takes up one bin and provides, as its inputs, two new bins for more elements to slot into. At the root of the tree, O=1. The tree is built recursively where each element d∈D is added as a child to the current node and then rolled out in full before the next element is added. If O≤0, the current node is a leaf, and the generator moves back up. In addition, if a node's depth is greater than or equal to m, only elements where d.l=0 may be added to the tree below that node. Specifically, the set of children for node N is computed according to equation (12):

$${N}_{d}^{( k )} ( O ) = \{ \begin{matrix}\{ d \vert d . I = 0 ∧ d ∈ 𝔻 \} & {O}_{d} = 0 ∧ {m}_{t} > 0 , \\ \{ d \vert d . I \geq 0 ∧ d ∈ 𝔻 \} & {O}_{d} > 0 ∧ {m}_{t} > 0 , \\ \{ End \} & {O}_{d} < 0 ∨ {m}_{t} \leq 0\end{matrix} \} \qquad ( 12 )$$

for the kth node. Finally, upon moving to a node's child, O is updated via:

Oₜ₋₁−1+dₜ.I→Oₜ (13)

where t represents the depth of the tree on a specific path. Essentially, the new operator is placed into a free slot and the new, d.l free slots are added. The method generates a tree of all possible prefix representations using elements D. This method forces validity in terms of the number of operands given to each element being equal to the number of operands that element accepts for every element in every possible path.

In large search problems, such as the case of symbolic regression, the search tree can be immense. For instance, in the relatively simple case of only two binary elements, two unary elements, and one variable or constant (meaning two elements with d.l=2, two with d.l=1, and one with d.l=0), the tree grows to over four million nodes with an operator depth of only m=7. In complex design problems, with many more types of elements, it is therefore completely infeasible to generate the entire search tree upfront. Therefore, the tree can be constructed as the algorithm runs, keeping the running variables of O and depth within each node. In this case, the GPTG does not run recursively, instead only generating a given node's children. It is then called again for each of those children as they are explored.

Under this tree structure, the optimization algorithm has two objectives that can be described based on two limiting conditions. First, in the case of |Pi|=0 ∀d∈D, the general ADP simplifies to a search of a large tree. In such a case, the Monte Carlo Tree Search is effective, as it is able to search the large tree without sampling each leaf. In the case of a single path down the tree, the problem simplifies to only searching the continuous parameter space of the involved elements. However, with a more expansive tree with >1 leaf and nontrivial elements, the parameter search and element search become intertwined and more complex.

Given a single path down the search tree (or a single system), there exist some set of optimal parameters given a deterministic evaluation function. Therefore, methods that directly solve for those parameters, such as gradient based methods or genetic algorithms, are applicable in the context of optimizing a single, deterministic system. However, in our tree structure, there is inherent uncertainty within the entirety of the search space due to the randomness of the Thompson Sampling. In addition, the systems themselves could be stochastic in a general ADP.

Instead, as illustrated in diagram 500 of FIG. 5, the stochastic elements of the tree and the error function can be bunched together into an overall simulator 505 corresponding with the behaviors of a set of elements. Therefore, the parameters 510 can be treated as continuous probability distributions that represent the posterior distribution 515—p(θ|F,T)—of the parameters (θ) given the design objectives (F) and rest of the tree T. In this sense, finding the optimal parameters becomes a likelihood-free inference problem. This framework is illustrated in chart 500 in FIG. 5. In the disclosed embodiments, the approximate Bayesian computation techniques can be applied.

With this framework, the inaccuracy of approximate Bayesian computation—sampling from p(θ|(M(θ)−x)<ε)1 instead of p(θ|x)—actually allows for a better framing of the problem. Under this framework, x is not a dataset as in normal likelihood-free inference. Instead, x represents the ideal design characteristics of a system (e.g., an RMS spot size of 0 in an optical system). As it is normally impossible for a system to perfectly match its ideal design criteria, the overall objective of the design process is to minimize a deviation between that ideal criteria and the performance of the actual system. Therefore, given some acceptable deviation ε, p(θ|F(θ,T)<ε) is actually the posterior that is desired. Note that we replace the selected elements D in the definition of the error function with T, because the posterior is considering the rest of the tree, not just one system. In this formulation, the posterior gives the designer the probability that a given design choice will provide performance that is at least as good as a deviation from the optimal design criteria or ε. By increasing the expectations on the system over time, and therefore decreasing ε, the acceptable deviation is minimized, and the system is optimized.

With these basic principles defined, the disclosed methods and systems combines ABC with Thompson Sampling while exploring paths down a search tree of possible combinations of elements. Each tree node holds statistical distributions for the parameters of its element. When a node is sampled as part of a path, its parameter values are also sampled from its distributions. Therefore, while sampling for the ABC part of the method, the method also learns what paths down the tree seem to work better by concurrently treating paths as bandits in the multi-armed bandit problem. As it learns what paths seem to work better, it samples those paths more, creating a feedback loop that converges upon the best path with the best parameter values. Importantly, the acceptable error (ε) decreases as the method is applied, tightening the feedback loop, and pushing the method toward convergence.

In accordance with the disclosed embodiments, Approximate Bayesian Computing Monte Carlo Tree Search can be used, as disclosed herein, to automate and optimize design. The key to the ABMCTS method is the combination of, and use of feedback between, the two methods Thompson Sampling and ABC as disclosed herein. This enables concurrent optimization of discrete and continuous aspects of symbolic regression and automated design problems.

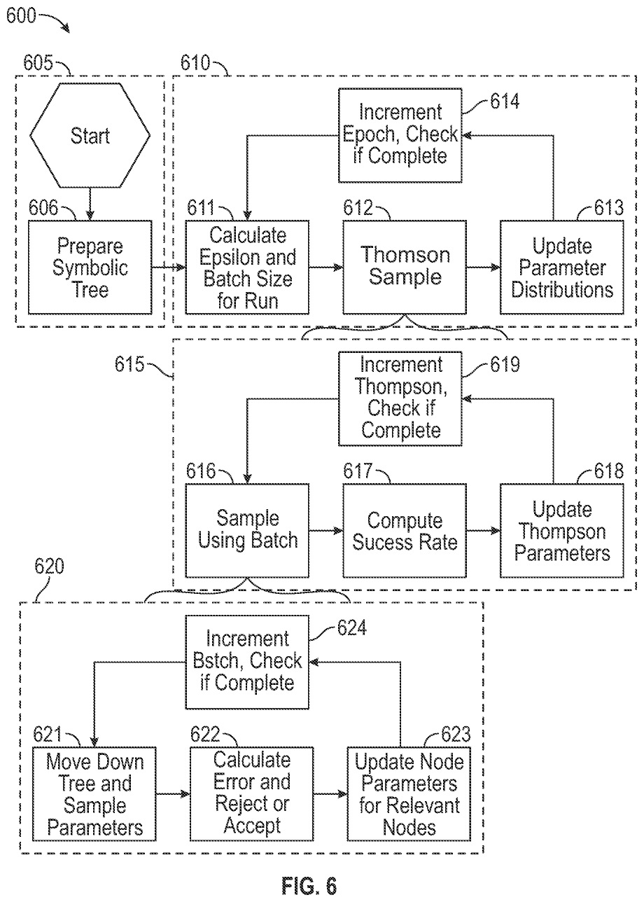

FIG. 6 illustrates a flowchart of the method in accordance with the disclosed embodiments. The method 600 generally includes four phases: a preparation phase, a parameter phase, a Thompson phase, and a rejection phase. After the preparation phase 605, the method operates according three nested phases: the Parameter Phase 610, the Thompson Phase 615, and the Rejection Phase 620.

The first step in the method 600 is the preparation phase 605. To prepare, the algorithm takes in D and initializes a tree as illustrated at 606, through the method described supra. In the event of this tree becoming too large for computer memory, the method for a rolling expansion can be applied. Each tree node is generated with two sets of distributions. First, each node contains a Thompson Distribution with starting values of α=2 and β=2. Second, each node contains N parameter priors for each of its respective N parameters. The priors can be set as uniform, although the design can use informative priors depending on their workflow. Table 1 provides a summary of the set of inputs and outputs of ABMCTS.

TABLE 1

| Inputs | Outputs |
|---|---|
| 1. Set of discrete elements [symbol] with each item dᵢ | 1. Thompson distributions for every element |
| including specifications for: | choice describing ABMCTS′ uncertainty about |
| N continuous parameters bounded by [aᵢ, bᵢ] | the probability that the design choice will lead to |
| N prior distributions | a success. |
| I inputs | |
| 2. Some metric for error | 2. Approximate probability distributions for every |
| Possibly non-differentiable | continuous parameter for every element describing |
| Possibly non-continuous | p(θ\|F(θ,T) < ε) |
| Maps s ∈ [symbol] → c ∈ [symbol] | |
| 3. Maximum number of elements with I ≠ 0 (m) | |

The next phase in the method 600 is the Parameter Phase 610. In the parameter phase 610, the parameters held by each node are updated using samples collected during the epoch's Thompson Phase. First, the batch size and the ε value for the epoch are calculated at 611. We define batch size to be the number of samples taken in each Rejection Phase. Because the tree is constrained by Thompson Sampling each epoch, normally fewer samples are necessary to explore the tree, and the batch size may be allowed to decrease. Reducing the batch size each epoch allows for a dramatic speed-up, and reducing the ε value is key to the algorithm's convergence.

Next, a Thompson Phase is carried out at 612 according to the batch size and ε just computed. During the Thompson Phase, a large number of samples down the tree are checked against ε using the error function F and accepted ones are kept.

Finally, the Parameter Phase concludes by updating the parameter distributions at 613 using the saved samples and incrementing the epoch at 614. Updates to the parameter distributions in the Parameter Phase and the Thompson distributions in the Thompson Phase only occur if there are more than five accepted samples through a node. This constraint prevents rapid fluctuations or restrictions in regions of the tree with very few samples.

The next phase in the method 600 is the Thompson Phase 615. In this phase, Thompson Sampling occurs under a specific state of the parameter distributions. The Thompson Sampling is key to the algorithm, as it directs future samples to regions of the search tree that seem to work better and, consequently, allows the number of samples to both decrease and become more sample-efficient over time. The Thompson Phase occurs over a set number of Thompson Updates, during which a batch of samples is run at 616, success rates are computed at 617 and the Thompson parameters are updated at 618. This can be used to update the Thompson distributions at 619 within the nodes. The separation of the Thompson Update from the other phases has two benefits.

First, the separation of the Thompson Updates from both the parameter updates in the Parameter Phase and the rejection sampling in the Rejection Phase is crucial to the systems validity. Generic Thompson Sampling assumes a constant sampling environment. This assumption breaks between two Parameter Phases because updating the parameter distributions at the end of the Parameter Phase 610 changes the likelihood of success given specific path choices. Therefore, updating the Thompson distributions in the Parameter Phase 610 would result in a changing environment between each Thompson Update and, consequently, would break a fundamental assumption of the technique.

Second, if Thompson Updates are conducted in the Rejection Phase 620, the number of Thompson Updates would be proportional to the batch size. As the batch size is largest in the early epochs of the algorithm, those early epochs would have a disproportionately large effect on the values of both α and β. As those early epochs have a large acceptable error, the algorithm may converge upon a path that is acceptable early on but fails to take into account certain details of the problem. In this case, because early epochs would have a disproportionate effect on the Thompson distributions, the algorithm would have a very difficult time getting out of that hole. Therefore, only through the separation of the Thompson Sampling into a distinct phase may both of these constraints be overcome

Essentially, this update is using the success rate of samples through a given node over the batch as the reward. Once the Thompson Distributions are updated, the algorithm checks if the Thompson Phase is over and either repeats the phase or moves on within the Parameter Phase.

It should be noted that the ratio between the number of Thompson Updates to the batch size must be balanced between too much information leakage between Thompson Phase (and corresponding ε values) at high numbers of Thompson Updates and reducing the effectiveness of the feedback loop (therefore reducing sample effectiveness and convergence) with low numbers of Thompson Updates.

The next phase in the method 600 is the Rejection Phase 620. In this phase, the rejection sampling for the ABC aspect of the algorithm occurs. For each sample, a path down the tree is taken according to the Thompson Sampling technique and parameters are sampled from the element parameter distributions in Pᵢ at 621. Once a path (system s) is selected, it is evaluated with the error function F and, if F (s)<ε, the sample is accepted and retained as illustrated at 622. The node parameter is updated for relevant nodes at 623. This process is repeated until the total number of samples meets the batch size constraint. In the Rejection Phase, priors from both previous Thompson Updates and Parameter Phases are considered while sampling. The batch is incremented and checked if it is complete at 624. Therefore, the algorithm carries information over from previous epochs. Because the size of the batch is the number of samples taken during this phase, the computational intensity of the phase decreases over the operation of the algorithm.

As described herein, the essence of this system and method is the feedback loop between the Thompson Sampling and the ABC. As the Thompson distributions are updated, the algorithm is better able to focus its sampling. Likewise, as the algorithm samples more in certain areas, its improved knowledge of the parameter distributions will likewise improve its understanding of the quality of the path. Therefore, it will be better able to update its Thompson distributions. As further detailed herein, the constantly decreasing ε pushes this process along by forcing the algorithm to find better routes down the tree.

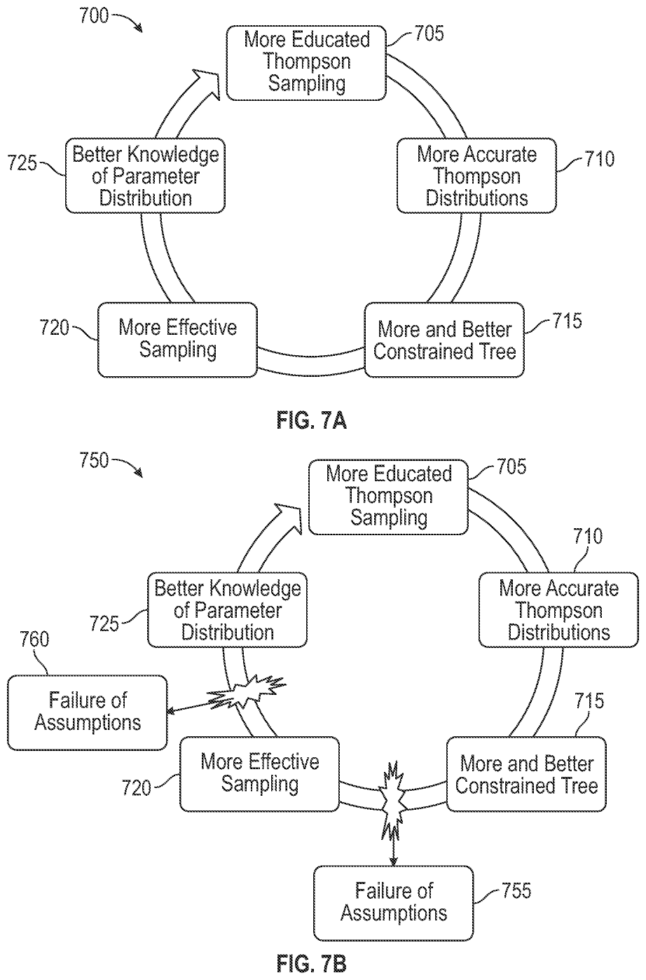

This process is illustrated in FIG. 7A and FIG. 7B. As illustrated by flow chart 700 at FIG. 7A the more educated Thompson sampling 705 results in more accurate Thompson distributions 710. This provides a more and better constrained tree at 715 and more effective sampling at 720. This results in in better knowledge of the element distribution at 725, which provides feedback resulting in more educated Thompson sampling. FIG. 7B illustrates a chart 750 of assumptions in failure loops. I this case failure of assumptions can occur between the constrained tree and more effective sampling at 755, or between the effective sampling and better knowledge of element distribution at 760.

It is important to note two key assumptions intrinsic to the operation. First, elements higher in the tree are more important to the behavior of the resulting sample than elements lower in the tree. In the beginning of the process, samples are more spread out over the tree. At this point, at higher levels of the tree, many samples are taken down each path and general information about node choices is gleamed. Because ε is high at this point, the smaller details defined further down the tree matter less to whether a path is accepted, while choices higher in the tree (with high sample density) are optimized through those high nodes' Thompson distributions. At the beginning of the process, fewer samples are taken on each node in lower levels of the tree, and, consequently, less information is gleamed regarding those nodes. However, as more epochs occur, ε decreases and the sampling space tightens. At this point, decisions in lower levels of the tree become more important to the overall performance of a path and have a high enough sample density to be optimized.

A corollary assumption is that design choices that are accepted while ε is high are worthy of further exploration. If paths accepted with a high epsilon are not worthy of further exploration, the algorithm would be unable to target its sampling when ε is low. Without this more effective sampling, better knowledge of elements' distributions is not obtained due to the curse of dimensionality.

Continually updating ε over the algorithm's runtime is essential for tightening the feedback loop between ABC and Thompson Sampling and, consequently, converging upon a solution. The input parameters for ε and its rate of decrease are important to the algorithm's performance.

Naively, a strictly decreasing epsilon may be implemented that diminishes according to some function of the epoch. However, such a method does not pardon variations in the rate of convergence over different Parameter Phases. If the rate of convergence does not follow the path of the function, then the algorithm may become stuck while unable to find and sample a path with sufficiently low error quickly enough to keep up.

Therefore, instead an adaptive approach can be applied. Specifically, we assume that, at each epoch, a successful system is defined as a system with an error lower than some proportion of the systems sampled in the previous epoch. This can be expressed by equation (14):

εₜ=R×C̅(̅x̅ₗ̅)̅ₜ̅₋̅₁̅ (14)

where R represents an Epsilon Ratio and t represents the epoch. By setting ε as a proportion of the previous epoch's central error, the rate of learning is not as rigorously enforced as in the strict approach. The median should be used as a measure of center in this case to avoid random fluctuations in ε due to abnormal samples.

Updating the Thompson Distributions

During the Thompson Phase, the Thompson distributions must be updated according to the numbers of successful and total samples taken through a given node. This process dictates both the tradeoff between exploring and exploiting the discrete element space and the meaning of the output. To account for different potential objectives, two methods of updating the Thompson distributions are disclosed.

In an embodiment, if p(F(s)<ε|dᵢ) is desired, that is the probability that a system (or sample) with element dᵢ will be successful, then the Thompson distributions would be updated as illustrated in equations (15) and (16):

$${α}_{t}^{( {d}_{i} )} = {α}_{t - 1}^{( {d}_{i} )} + \frac{{g}^{( {d}_{i} )}}{{T}^{( {d}_{i} )}} \qquad ( 15 )$$

$${β}_{t}^{( {d}_{i} )} = {β}_{t - 1}^{( {d}_{t} )} + \frac{{T}^{( {d}_{i} )} - {g}^{( {d}_{i} )}}{{T}^{( {d}_{i} )}} \qquad ( 16 )$$

where g is the number of successful samples and T is the number of total samples for node di. Although this method provides useful information, it can often induce bias against elements with high variation. For instance, consider two elements (A and B) each part of one of two equivalently optimal paths. If element A has I=2 while element B has I=1, then A will be a root node for a larger subtree than B. Therefore, during early epochs, when the probabilities of sampling A or B are comparable, gA<gB, assuming otherwise equivalent situations (e.g., equivalent, equally uninformative priors on parameters, uninformative Thompson distributions, etc.). Under this method of updating the Thompson distributions, A will not be explored as much as B, biasing the algorithm against A.

Thus, if p(∃s s. t. di∈s∧F(s)<ε|dᵢ) is desired, that is the probability that a successful system with di exists, then the Thompson distributions can be updated as given in equations (17) and (18):

$${α}_{t}^{( {d}_{i} )} = - \{ \begin{matrix}{α}_{t - 1}^{( {d}_{i} )} + 1 & {g}^{( {d}_{i} )} > 0 \\ {α}_{t - 1}^{( {d}_{i} )} & {g}^{( {d}_{i} )} = 0\end{matrix} \qquad ( 17 )$$

$${β}_{t}^{( {d}_{i} )} = - \{ \begin{matrix}{β}_{t - 1}^{( {d}_{i} )} & {g}^{( {d}_{i} )} > 0 \\ {β}_{t - 1}^{( {d}_{i} )} + 1 & {g}^{( {d}_{i} )} = 0\end{matrix} \qquad ( 18 )$$

This method is more sample inefficient because it does not eliminate systems that are rarely successful. However, it does allow for more exploration throughout the training.

There are no theoretical constraints on the implementation of the ABCSMC component of ABMCTS. However, certain implementation details, such as a thin transition kernel, could impede learning. Therefore, a description of the implementation of ABCSMC in certain exemplary embodiments is provided.

In certain embodiments, a uniform component-wise transition kernel can be used. A uniform kernel can be selected for its computational simplicity. As the kernel is applied to points numbering potentially in the hundreds for each node, a fast kernel is optimal for reasonable runtimes.

Choosing the radius of the uniform kernel a is an important decision for describing the behavior of the ABCSMC. Naively, a is set for each iteration at initialization. However, it can be more generally set to be adaptive to the state of the intermediate distribution. In order to create an adaptive system while still forcing enough convergence to provide the necessary information for the Thompson sampling to improve, σ can be set for parameter p at iteration t according to equation (19):

σₜ^{(p)}=a_{SMC}b_{SMC}^{t}(max(samplesₜ^{(p)})−min(samplesₜ^{(p)})) (19)

where aSMC and bSMC are hyperparameters that describe the rate of constraint.

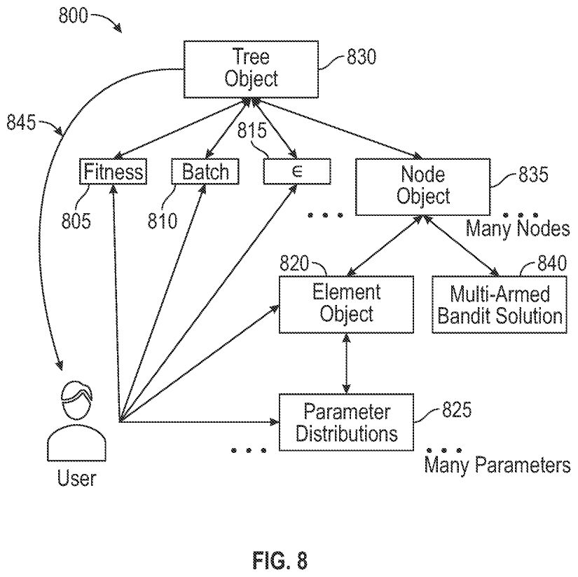

FIG. 8 illustrates a system 800 for automated design, in accordance with the disclosed embodiments. Aspects of the system 800 can be embodied as software or hardware modules associated with a computer system as illustrated in FIGS. 1-3. As illustrated in FIG. 8 the system 800 can include a fitness module 805, batch module 810, epsilon module 815, as well as an element object module 820 and a parameter distribution module 825.

In accordance with the disclosed embodiments, the system 800 can be configured to accept input through a user interface. The input can include selection of a fitness function for the fitness module, selection of a batch function linking batch size to the epoch, and selection of the epsilon function linking ε to the epoch. These selections can be made according to the application for which the automated design is required. The input can also include the set of element objects to the element object module, and the priors for the parameter distribution module.

With these inputs the system 800 can use the methods outlined herein to prepare a symbolic tree structure with the tree object module 830. The node symbol parameters can be updated by the node object module 835 using a plurality of samples. The system 800 can use solutions to the multi-armed bandit problem generated with the multi-armed bandit solution module 840, promoting each sample down a path of the symbolic tree. The system 800 can further evaluate each path with the fitness functions from the fitness function module in order to provide output 845 which can comprise one or more paths along the tree structure.

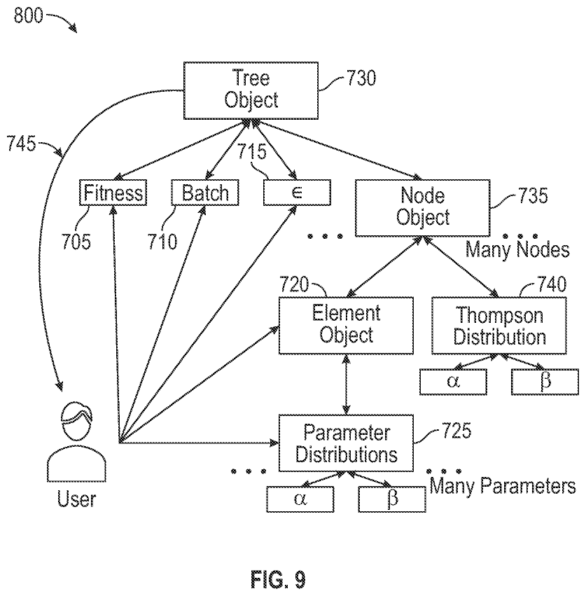

It should be appreciated that the multi-armed bandit solution module 840 can make use of Thompson sampling in exemplary embodiments, as detailed herein, and illustrated in FIG. 9. However, in other embodiments, other solution methods for the multi-armed bandit problem can be implemented by the multi-armed bandit solution module 840. One such alternative solution 3 could be an epsilon-greedy solution.

It should be understood that the methods and systems disclosed herein have been described in exemplary fields including optical design and circuit design. It should be appreciated that, in other embodiments, the automated design methods and systems disclosed herein can be applicable in other fields. For example, in certain embodiments, the disclosed methods and systems are operable for “autoML” or automatically designing neural networks.

In an exemplary embodiment, the systems and methods described herein can be used to develop an optimized optical system. It should be appreciated that the systems and methods can similarly be used more generally for design optimization of other systems. Herein an exemplary application of the systems and methods to an optical design system is provided. This is for purposes of illustration, and is not meant to limit the disclosure to the field of optics.

In an embodiment, optical design optimization requires identity of the optimal set of optical elements and their parameters that fits given design objectives. The problem is extremely difficult. It suffers from high parameter dimensionality, strong correlations between parameters, many local minima, and a complex parameter search space. Additional difficulties include the challenge of optimizing the length of the system separately as a discrete component of the optimization, and the possibility of varying parameter dimensionalities between lenses, mirrors, and other elements. The complete, general ADP for optical systems, including these discrete aspects, is an excellent example of the potential application of the disclosed embodiments.

For purposes of illustration, the disclosed methods and systems can be directed to an optical optimization problem where the ideal system has been empirically identified. The design problem requires a three-lens system with a focal length of 100 mm, a F/number of 3.0, and a field angle of 38.0°. For purposes of this illustration, the length constraint is defined as ≤3 lenses in order to expand the problem to a general ADP. In such a system, the theoretically optimal lens set, known as a “Cooke Triplet” or “Triplet” herein, is a set of two positive lenses separated by one negative lens. This set has been empirically identified as optimal because it is known to correct all Seidel and Chromatic optical aberrations. Therefore, the disclosed systems and methods can be configured to find and optimize such a triplet system, or more generally, any other design optimization problem with discreet and continuous parameters.

The system can accept as input, six possible lens geometries: biconvex, biconcave, convex concave, concave convex, biconvex high, and biconcave high. The latter two geometries are defined with the same behaviors as the biconvex and biconcave lenses respectively, but with higher indices of refraction and higher curvatures (i.e., lower radii of curvature). Additionally, an aperture element is added as the leaf node. This acts to reverse the system which helps hold to the systems assumptions. In this case, all elements have I=1 except the aperture, which has I=0.

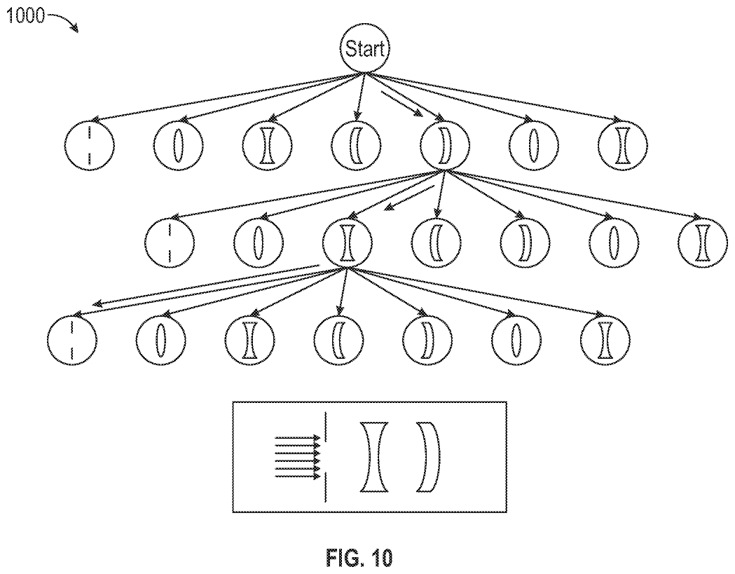

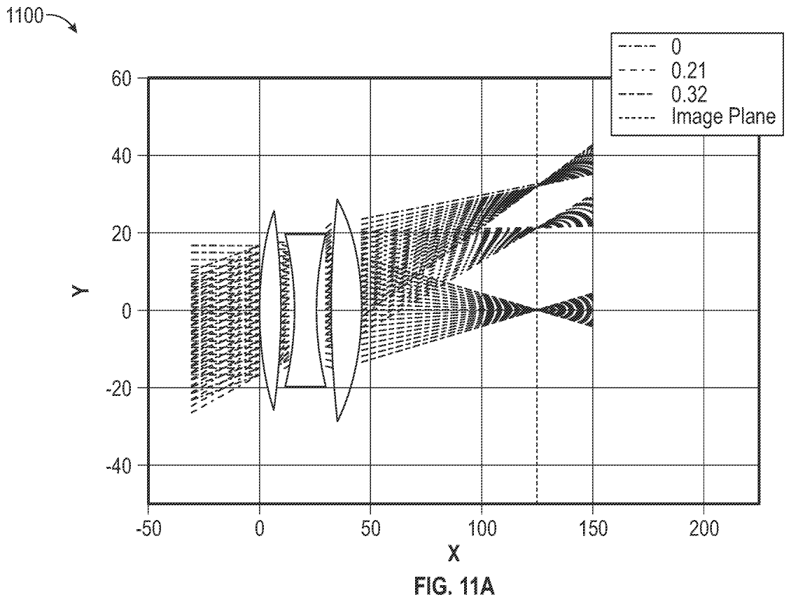

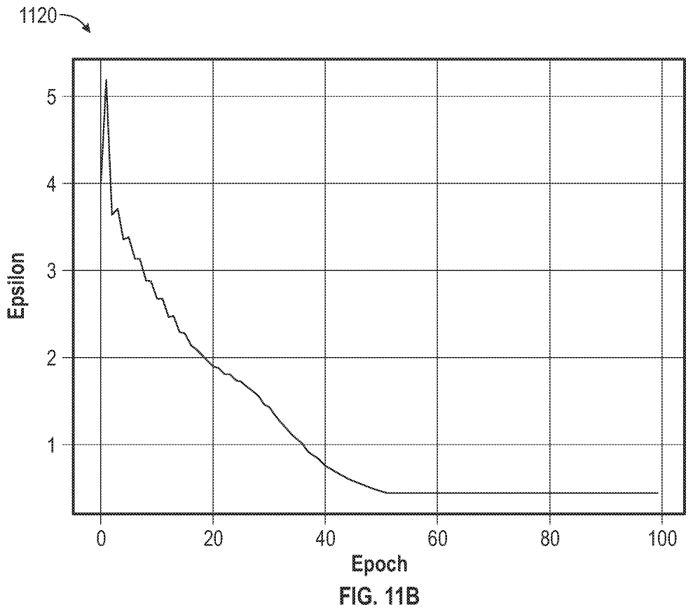

As each element in the optical system could be of any geometry, the children of any node can be set to be that same set of six geometries and the aperture. Therefore, any path down the tree represents a string of geometries in reverse order. A subtree of this tree and an example path is illustrated in tree 1000 of FIG. 10. This ordering also helps to abide by the assumption that elements higher in the tree are more important to overall behavior, the order of the lenses is flipped in the optical system within the error function. This way, the highest lens in the tree is the last lens in the system and most directly impacts the image.

A combination of RMS spot size and distortion can be selected as the error function for our optical test case because of its widespread use in the optical optimization problem. RMS spot size describes the clarity of the image formed by the optical system while distortion accounts for deviations in image scale. RMS spot size is computed according to equation (20):

R=Σ{square root over (Σₖ₌₁⁺[∥(xₖ−x₀∥²]/30)} (20)

with the Euclidean norm and distortion according to equation (21):

D=Σ|x̅−x̅_{ideal}| (21)

where x_{ideal} is the image of the central ray traced paraxially through the system. To compute the final error, a weighted average of these two components can be taken:

F(s)=½[w₁F(s)+w₂D(s)] (22)

w₁ is set as w₁=2 and w₂ is set as w₂=1. 30 rays can be traced through the system for each of three angles—{0, 0.65φ, φ}, φ=38.0° or the field angle. The rays can be placed into a circular pattern by a ray tracing package. Because the circular geometry constructed concentric rings of evenly spaced rays, the rings on the outside of the pattern have more rays than the interior rings. Therefore, the aberrations within the system may be exaggerated.

In an optical design problem, it is may be desired that the focal length of the optimized system is exactly equal to the desired focal length. Therefore, the parameters for the final lens of the system can be based on the desired focal length and the rest of the system. Following this convention, the final surface in the system will lead to an overall focal length equal to the desired one. This calculation is performed according to paraxial optics.

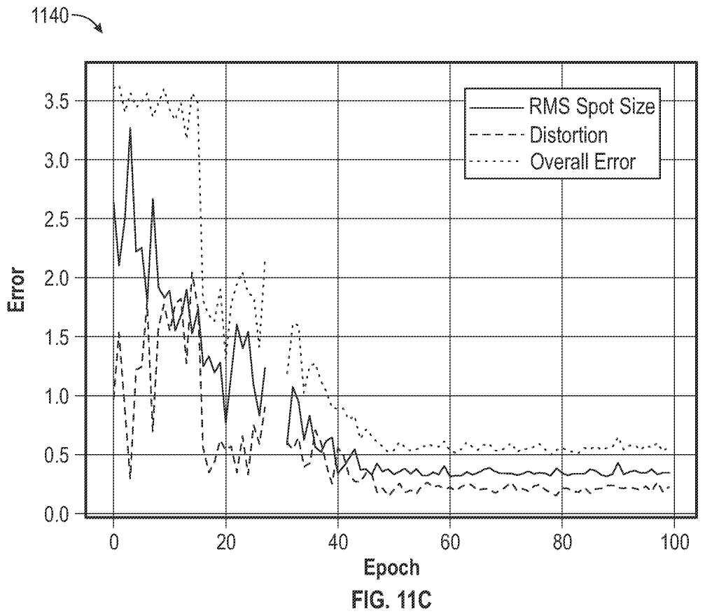

In an exemplary embodiment the disclosed methods and system are able to find and optimize a Triplet set. The resulting optical system is illustrated in chart 1100 in FIG. 11A, and the graph of ε over time is shown in chart 1120 of FIG. 11B.

In this example, the system can sample 389,560 systems. The system found a system with a weighted error was 0.49±0.021. The RMS spot size component of that metric was 0.35±0.024 while the distortion component was 0.21±0.029 8. Each component's evolution over training is diagrammed in chart 1140 in FIG. 11C.

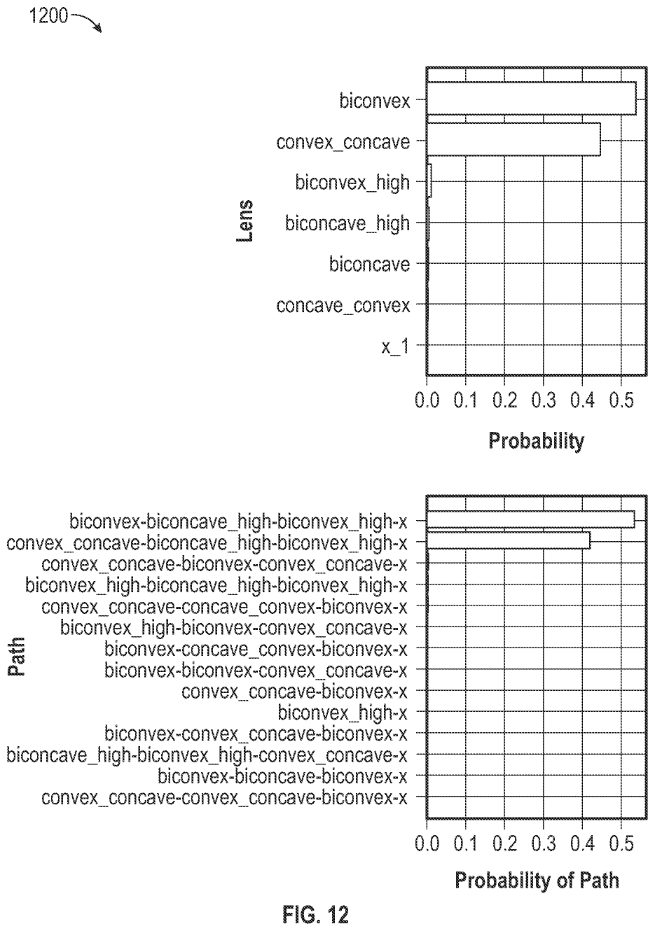

In addition to these numerical results, the final parameter distributions and Thompson distributions illustrate the system's ability to provide useful information about each individual design choice. Because optical systems encoded in the tree are in reverse order the probabilities represent the probabilities that the system choses the path where the given geometry is last in the system and first in the path. The output of the system is illustrated in chart 1200 of FIG. 12.

From these probabilities, it is clear the system correctly identified the biconvex lens as the most likely to have the highest probability of success. It also identifies a convex concave lens as a contending geometry. This is expected because of the constraint on the final radius of curvature. The rear positive radius of curvature of the convex concave lens is not important as the constraint overrides it before the system is evaluated. Therefore, these results demonstrate the system's ability to find multiple feasible systems during a single unsupervised optimization run.

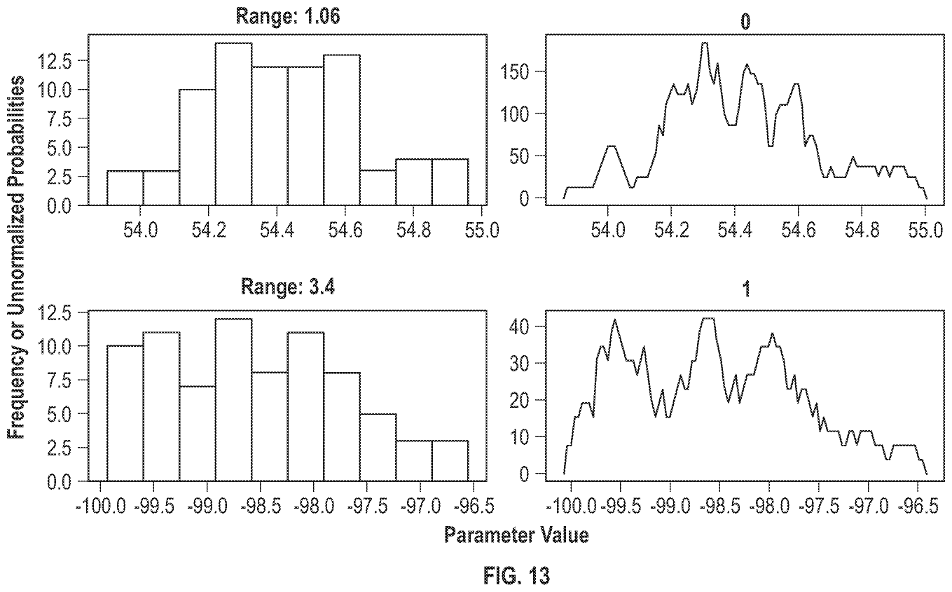

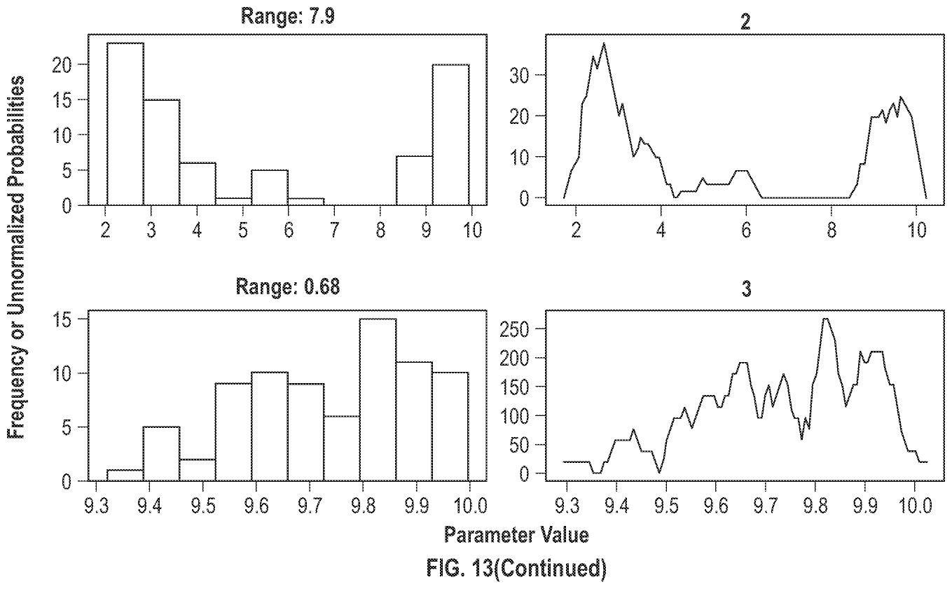

The system can also be configured to output approximate parameter distributions for each parameter in the optical system. These parameter distributions are constructed from the set of accepted samples in the (t−1)^{st} iteration according to ABCSMC. Therefore, the histogram of the samples taken in the final epoch and the respective parameter sampling distributions are considered (which use the ABCSMC transition kernel). The distributions for the first biconvex lens (which is the lowest lens in the tree) is included in chart 1300 in FIG. 13. The noise in chart 1300 may be due to the small transition kernel that is applied late in the training. The multi-modality of the distributions demonstrates ABMCTS' ability to isolate multiple possible local minima for further investigation.

The disclosed embodiments are directed to solutions of a general definition of an automated design problem (ADP) and associated method, ABMCTS, that is able to solve general ADPs. The methods and systems ability to perform optimization in two distinct applications of automated design is an aspect of the embodiments. In both cases, ABMCTS can provide a rapid optimization of both the interlocked discrete elements and continuous parameters within the design problem. Additionally, ABMCTS can provide statistical information about the problem and the design process, including parameter certainties and probabilities-of-success for different design choices.

Likewise, in other embodiments, the disclosed systems and methods can be used for any sort of automated scheduling problem where specific events are sequential in time. Exemplary embodiments include telescope scheduling or refinery scheduling.

Likewise, in other embodiments, the systems and methods disclosed herein can be used for bridge design problems where parts of the bridge structure are added with their continuous parameters such as orientation and location and their discrete elements being material. Another example is traffic/civil design where roads would act similarly to wires in circuits. This problem is more difficult than the electrical design problem because the specific path of the roads matters and is continuous while wires can just be described as connectors. Another application includes music composition where the discrete aspect is the next note, and the continuous aspect is the length of the note. This would require defining an associated fitness function.

The primary benefits of the embodiments disclosed herein are threefold. First, the fitness function can be anything. Therefore, this method can be used in a wide variety of applications with a wide variety of fitness functions (even ones that are non-differentiable). Second, little modification is required to apply this method to a wide variety of problems. All the users must do is develop a problem specific fitness function and provide a list of elements along with (1) their input dimensionality and (2) their parameter distribution priors. However, in testing, the algorithm seemed to work well with uniform parameter priors, so the requirement of parameter distribution priors only provides the user more control over the algorithm. Finally, the disclosed embodiments provide substantial information regarding which paths are better and by how much. Due to the results of the Thompson Sampling, every path has a probability distribution associated with how the algorithm views its reward probability. Therefore, unlike other modern automated design algorithms, such as a genetic algorithm, this method allows the user to gain metrics for how much better one design choice is over another.

Based on the foregoing, it can be appreciated that a number of embodiments, preferred and alternative, are disclosed herein. It should be appreciated that variations of the above-disclosed and other features and functions, or alternatives thereof, may be desirably combined into many other different systems or applications. It should be understood that various presently unforeseen or unanticipated alternatives, modifications, variations, or improvements therein may be subsequently made by those skilled in the art which are also intended to be encompassed by the following claims.

What is claimed is:

1. A design optimization method comprising:
preparing a symbolic tree;
updating node symbol parameters using a plurality of samples;
sampling the plurality of samples with a method for solving a multi-armed bandit problem;
promoting each sample in the plurality of samples down a path of the symbolic tree;
evaluating each path with a fitness function; and
outputting a path of the symbolic tree.

2. The design optimization method of claim 1 further comprising:
providing at least one design parameter.

3. The design optimization method of claim 2 wherein the at least one design parameter comprises one of:
a discrete parameter; and
a continuous parameter.

4. The design optimization method of claim 1 further comprising:
providing a plurality of design parameters, the plurality of design parameters further comprising: discrete parameters and continuous parameters.

5. The design optimization method of claim 1 wherein the method for solving the multi-armed bandit problem comprises Thompson sampling.

6. The design optimization method of claim 5 further comprising:
sampling using batch;
computing a success rate; and
updating Thompson parameters.

7. The design optimization method of claim 1 further comprising:
providing an error function, the error function defining a design objective.

8. The design optimization method of claim 7, wherein the design objective comprises an optical system design objective.

9. A computer implemented optimization method comprising:
initializing a symbolic tree in a preparation phase;
updating parameters held by each node in the symbolic tree using samples collected during an epoch in a parameter phase;
evaluating at least one sample down the symbolic tree with Thompson sampling in order to select at least one sample in a Thompson phase; and
updating parameter distributions using the selected at least one sample and incrementing the epoch in a rejection phase.

10. The computer implemented optimization method of claim 9 wherein the preparation phase further comprises:
generating a tree node with two sets of distributions, wherein each tree node contains a Thompson Distribution.

11. The computer implemented optimization method of claim 9 wherein each node contains a plurality of parameter priors for each of its respective parameters.

12. The computer implemented optimization method of claim 9 wherein the parameter phase further comprises:
determining a batch size and an error value for the epoch.

13. The computer implemented optimization method of claim 12 wherein the parameter phase further comprises:
setting a batch size to be a number of samples taken in each rejection phase.

14. The computer implemented optimization method of claim 9 wherein the parameter phase further comprises:
updating parameter distributions using saved samples and incrementing the epoch.

15. The computer implemented optimization method of claim 9 wherein the rejection phase further comprises:
evaluating an error function for a selected path on the symbolic tree.

16. The computer implemented optimization method of claim 15 wherein the error function defines a design objective.

17. An optimization system comprising:
a computer system, the computer system further comprising:
at least one processor;
a graphical user interface; and
a computer-usable medium embodying computer program code, the computer-usable medium capable of communicating with the at least one processor, the computer program code comprising instructions executable by the at least one processor and configured for:
preparing a symbolic tree;
updating node symbol parameters using a plurality of samples;
sampling the plurality of samples with a method for solving a multi-armed bandit problem;
promoting each sample in the plurality of samples down a path of the symbolic tree;
evaluating each path with a fitness function; and
outputting a path of the symbolic tree.

18. The optimization system of claim 17 further comprising:
providing at least one design parameter, the at least one design parameter comprising one of:
a discrete parameter; and
a continuous parameter.

19. The optimization system of claim 17 wherein the method for solving the multi-armed bandit problem comprises Thompson sampling further comprising sampling using batch; computing a success rate; and updating Thompson parameters.

20. The design optimization system of claim 17 further comprising:
providing an error function, the error function defining a design objective.
